(19) United States
(12) Patent Application Publication
(10) Pub. No.: US 2017/0306654 A1
(43) Pub. Date: Oct. 26, 2017

(54) MORTISE DEVICE

(71) Applicant: SAMSUNG SDS CO., LTD., Seoul (KR)

(72) Inventor: Chul Ho MAENG, Seoul (KR)

(73) Assignee: SAMSUNG SDS CO., LTD., Seoul (KR)

(21) Appl. No.: 15/488,690

(22) Filed: Apr. 17, 2017

(30) Foreign Application Priority Data
Apr. 22, 2016 (KR) 10-2016-0049533

(51) Int. Cl. E05B 63/04; E05B 63/08; E05B 55/00

(52) U.S. Cl. CPC E05B 63/044; E05B 55/00; E05B 63/08

(57) ABSTRACT

Provided is a mortise device. According to one embodiment, the mortise device includes a mortise installed at a door, a face plate coupled to one side surface of the mortise, a latch bolt which thrusts out of or retracts into the one side surface of the mortise to which the face plate is coupled, a guide protrusion formed on the latch bolt, and a fixing pin which allows the latch bolt to be installed in the mortise.

### CROSS-REFERENCE TO RELATED APPLICATION

This application claims priority to and the benefit of Korean Patent Application No. 10-2016-0049533, filed on Apr. 22, 2016, the disclosure of which is incorporated herein by reference in its entirety.

### BACKGROUND

### 1. Field of the Invention

The present invention relates to a mortise device.

### 2. Discussion of Related Art

Generally, a door lock includes a latch bolt that thrusts out of a side surface of a door and is also retracted in by an operation of a rotating mechanism such as a lever or the like. The latch bolt is a mechanism for preventing a door from automatically being opened and may be used together with a dead bolt in some cases.

For locking and unlocking a door, a mortise including a latch bolt is used in a door lock. Here, installation direction of a latch bolt needs to be different depending on opening and closing directions of a door. A mortise is installed in a door and connected with a handle to move a latch bolt to lock or unlock depending on rotation direction of the handle, thereby opening and closing the door. Such a door lock is classified as a counterclockwise type or a clockwise type depending on the opening and closing directions of a door.

A conventional door lock mortise has driving directions different from each other depending on whether a door opens toward inside of a room or toward outside of a room. When the door opening direction of a door whose mortise is installed for opening toward inside needs to be modified to open toward outside, the already installed mortise is unusable, and a new mortise for opening toward the outside needs to be installed.

### RELATED ART DOCUMENT

Patent Document

(Patent Document 0001) Korean Patent Application Publication No. 10-1263446 (May 3, 2013)

### SUMMARY OF THE INVENTION

The present invention is directed to providing a mortise device for which a latch bolt is easily switched between counterclockwise direction and clockwise direction without disassembling a face plate.

In addition, the present invention is directed to providing a mortise device for which it is easy to switch a latch bolt direction and separation of a latch bolt due to an impact caused by opening and closing of a door is prevented.

According to an aspect of the present invention, there is provided a mortise device including: a mortise installed at a door; a face plate coupled to one side surface of the mortise; a latch bolt which thrusts out of or retracts into the one side surface of the mortise to which the face plate is coupled; a guide protrusion formed on the latch bolt; and a fixing pin which allows the latch bolt to be installed in the mortise.

The fixing pin may be positioned at any one place of the face plate and the mortise.

A lead-in slot for positioning the fixing pin may be formed at any one place of the face plate and the mortise in which the fixing pin is positioned.

The fixing pin may be positioned between the face plate and the mortise.

The fixing pin may include a base portion and an arm portion, and the arm portion may be formed to be bent in an inward direction of the other side of the mortise.

The fixing pin may prevent the latch bolt from being separated by being in contact with and supporting the guide protrusion.

The fixing pin may allow the latch bolt to be detached from and installed in the mortise.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a view illustrating a latch bolt and a fixing pin according to one embodiment of the present invention;

FIG. 2 is a view illustrating a latch bolt according to one embodiment of the present invention;

FIG. 3 is a view illustrating a fixing pin according to one embodiment of the present invention;

FIG. 4 is a view illustrating a mortise device according to one embodiment of the present invention;

FIG. 5 is a cross-sectional view illustrating a mortise device according to one embodiment of the present invention;

FIG. 6 is a cross-sectional view when a fixing pin is installed at a latch bolt at which a guide protrusion is formed according to one embodiment of the present invention;

FIG. 7 is a view illustrating a bent fixing pin according to one embodiment of the present invention;

FIG. 8 is a view illustrating a latch bolt at which a bent fixing pin is installed according to one embodiment of the present invention;

FIG. 9 is a view illustrating a fixing pin in which a concave groove is formed according to one embodiment of the present invention; and

FIG. 10 is a cross-sectional view illustrating a mortise device according to one embodiment of the present invention.

### DETAILED DESCRIPTION OF EXEMPLARY EMBODIMENTS

Hereinafter, exemplar embodiments of the present invention will be described in detail with reference to the accompanying drawings. However, the embodiments should be considered as being descriptive only, and the present invention is not limited to the embodiments set forth herein.

In the description, detailed descriptions of well-known technologies related to the present invention will be omitted when they may unnecessarily obscure the subject matters of the invention. In addition, terms described below are defined considering functions of the present invention, and the terms may be changed by intention or practice of users and operators. Thus, definitions of these terms have to be made on the basis of the content throughout the specification.

Inventive concept of the present invention shall be determined only according to the technical sprit of the attached claims, and the embodiments below are provided only to efficiently convey the concept of the present invention to those skilled in the art.

A mortise device 100 according to the embodiment of the present invention is installed on a door and may easily have the direction of a latch bolt 10 which locks and unlocks the door change between counterclockwise direction and clockwise direction.

The mortise device 100 may include the latch bolt 10, a face plate 20, a mortise 30, a cover 40, and a fixing pin 50. The latch bolt 10 may thrust out of the mortise 30 or retract into the mortise 30 to lock or unlock the door. Here, the latch bolt 10 is detachable from the mortise 30 and easily switched between counterclockwise direction and clockwise direction. A guide protrusion 121 and the fixing pin 50 are included for detachably installing the latch bolt 10 on the mortise 30 for easily switching between counterclockwise direction and clockwise direction.

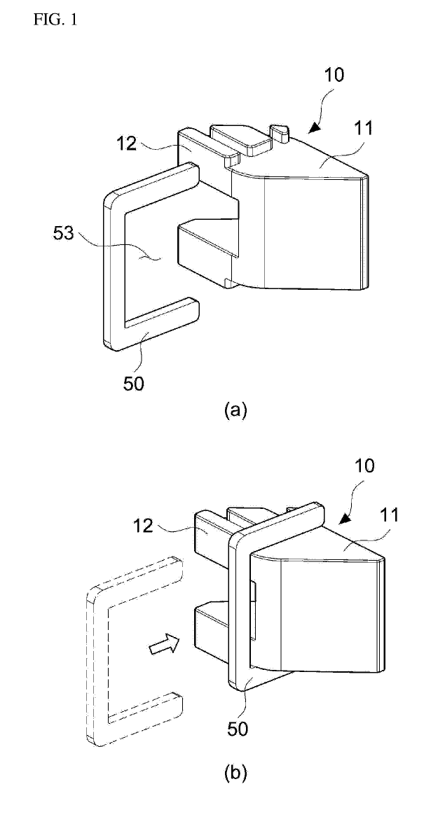

FIG. 1 is a view illustrating the latch bolt 10 and the fixing pin 50 according to one embodiment of the present invention.

Referring to FIG. 1, the mortise device 100 may include the latch bolt 10 and the fixing pin 50. The latch bolt 10 may include a latch front end 11, a latch shaft 12, and the guide protrusion 121. The latch front end 11 is a portion of the latch bolt 10 which may be exposed in one side direction of the mortise 30. The slopes of the both side directions of the latch front end 11 are formed to have different slopes to form a latch bar portion in a direction (inside direction or outside direction). One surface of the latch front end 11 may be obliquely formed. Both side surfaces of the latch front end 11 may have sloped angles different from each other. For example, one surface of the latch front end 11 may be a level surface while the other surface is formed as a sloped surface. The level surface of the latch front end 11 may be formed in an outward direction in which the door opens, and the sloped surface of the latch front end 11 may be formed in an inward direction in which the door closes.

The latch shaft 12 may be a portion of the latch bolt 10 inserted into the mortise 30. The guide protrusion 121 may be formed on the latch shaft 12. The latch bolt 10 may be supported in one side direction by the guide protrusion 121, in the mortise 30. Here, the term “one side” refers to a width direction of the door, and specifically a direction in which the latch bolt 10 may protrude.

The fixing pin 50 may be installed at the latch bolt 10. The fixing pin 50 may prevent the latch bolt 10 from being separated by being in contact with and supporting the guide protrusion 121. Each configuration of the latch bolt 10 and the fixing pin 50 will be described below.

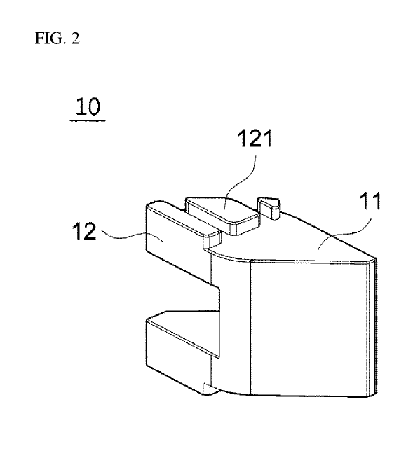

FIG. 2 is a view illustrating the latch bolt 10 on which the guide protrusion 121 is formed according to one embodiment of the present invention.

Referring to FIG. 2, the latch bolt 10 may thrust out of the mortise 30 or retract into the mortise 30. The latch front end 11 protrudes in one side direction with respect to the face plate 20, that is, outward from the mortise 30, and the latch shaft 12 retracts into the other side direction, that is, toward inner side of the mortise 30. The latch bolt 10 may include the guide protrusion 121.

The guide protrusion 121 may be formed on the latch shaft 12 inserted into the inner side of the mortise 30. The guide protrusion 121 may prevent the latch bolt 10 from being separated toward the one side by being in contact with and supporting the fixing pin 50. Specifically, the guide protrusion 121 formed on the latch bolt 10 may be formed at a position which may be in contact with and support the other side of the fixing pin 50. For example, the guide protrusion 121 of a predetermined height may be formed on at least a portion of an upper side and a lower side of the latch shaft 12 (upper side and lower side of FIG. 2) with which an arm portion 52 of the fixing pin 50 may be in contact. However, the guide protrusion 121 is not limited thereby, and the guide protrusion 121 of a predetermined height may be formed at a portion of at least left side and right side of the latch shaft 12 (left side and right side of FIG. 2) with which a base portion 51 of the fixing pin 50 may be in contact. The guide protrusion 121 may be formed with a predetermined height in a range within which the latch bolt 10 is fixedly installed in the mortise 30 and does not interfere with other components in the mortise 30.

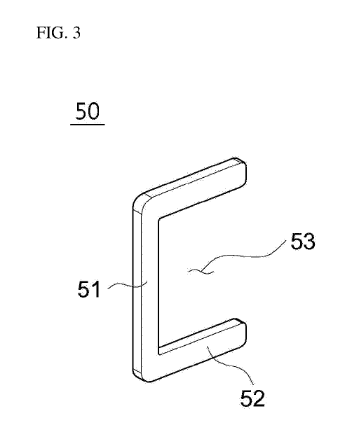

FIG. 3 is a view illustrating the fixing pin 50 according to one embodiment of the present invention.

Referring to FIGS. 1 and 3, the fixing pin 50 may include the base portion 51, the arm portion 52, and a latch hole 53. The base portion 51 may be in contact with a side surface of the latch bolt 10, the arm portion 52 may be in contact with each surface of upper side and lower side of the latch bolt 10, and thereby the latch bolt 10 is prevented from being separated in one side direction. Here, the term “contact” may refer to being in a contact to an extent that allows the latch bolt 10 to move through the latch hole 53.

The fixing pin 50 may include the latch hole 53 which allows the latch bolt 10 to move. The fixing pin 50 may be a shape which surrounds at least a portion of the latch bolt 10 including a shape, a C shape, a pin shape, a circular shape, a quadrilateral shape, a polygonal shape, etc.

The fixing pin 50 may allow the latch bolt 10 to be installed in the mortise 30. The fixing pin 50 may prevent the latch bolt 10 from being separated in one side direction and allow the latch bolt 10 to be installed in the mortise 30. The fixing pin 50 may be in contact with a plurality of faces of the latch bolt 10 to prevent the latch bolt 10 from being separated from the mortise 30. More specifically, the fixing pin 50 may be positioned between the latch front end 11 and the latch shaft 12. The fixing pin 50 may fix the latch front end 11 in a state of being positioned at an outer side of the mortise 30 in one side direction and fix the latch shaft 12 being positioned at an inner side of the mortise 30 in the other side direction. Therefore, the fixing pin 50 may not allow the latch shaft 12 to protrude outwards from the mortise 30 due to the fixing pin 50. The fixing pin 50 may prevent the latch bolt 10 from being separated by being in contact with and supporting the guide protrusion 121.

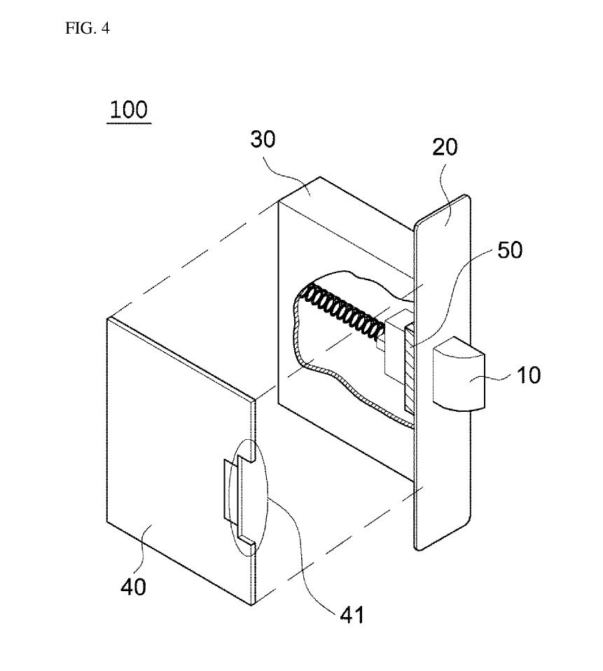

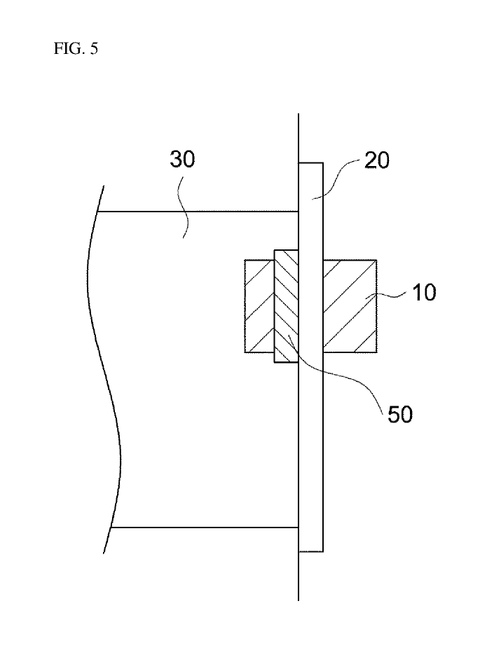

FIGS. 4 and 5 are views illustrating the mortise device 100 according to one embodiment of the present invention.

Referring to FIGS. 4 and 5, the mortise device 100 may include the latch bolt 10, the face plate 20, the mortise 30, the cover 40, and the fixing pin 50.

The latch bolt 10 may thrust out of one side surface of the mortise 30 to which the face plate is coupled or retract into the mortise 30. The latch bolt 10 may be connected with a fixed part inside the mortise 30 through a spring. The latch bolt 10 may be moved to open a door and may be returned back to an original position by recoil of the spring. When the latch bolt 10 returns back to the original position, the latch bolt 10 thrusts out of one side surface of the mortise 30 not allow the door to be opened.

The mortise device 100 disposed at a door may include the mortise 30 in which a number of components related to driving the latch bolt 10 and a dead bolt are equipped. A door may be locked or unlocked due to the latch bolt 10 thrusting out of the mortise 30 or retracting into the mortise 30. The face plate 20 may be coupled to one side surface of the mortise 30. In addition, the mortise device 100 may include the cover 40 which covers the mortise 30.

The fixing pin 50 may allow the latch bolt 10 to be installed in the mortise 30. The fixing pin 50 may prevent the latch bolt 10 from being separated in one side direction and allow the latch bolt 10 to be installed in the mortise 30. The fixing pin 50 may be positioned at a place of the face plate 20 and the mortise 30. A lead-in slot 41 for positioning the fixing pin 50 is formed at any one place of the face plate 20 and the mortise 30, at which the fixing pin 50 is positioned. The lead-in slot 41 is formed in the mortise 30 in FIGS. 4 and 5 but is not limited thereto, and the lead-in slot 41 may also be formed in the face plate 20 to position the fixing pin 50. Besides, the fixing pin 50 may be positioned between the face plate 20 and the mortise 30. The fixing pin 50 may be positioned at any one place of the face plate 20, the mortise 30, and between the face plate 20 and the mortise 30 to support and be in contact with the latch shaft 12.

A detaching groove (not shown) may be formed in the cover 40 to easily detach the fixing pin 50. For example, the detaching groove may be formed around the lead-in slot 41 of the cover 40 to conveniently detach the fixing pin 50 using a screwdriver or a pin. Alternatively, the fixing pin 50 may also be detached using a push button method, of course. Here, a method of easy detachment is not limited to the button or groove and may include any method or mechanism which easily detaches the fixing pin 50 installed.

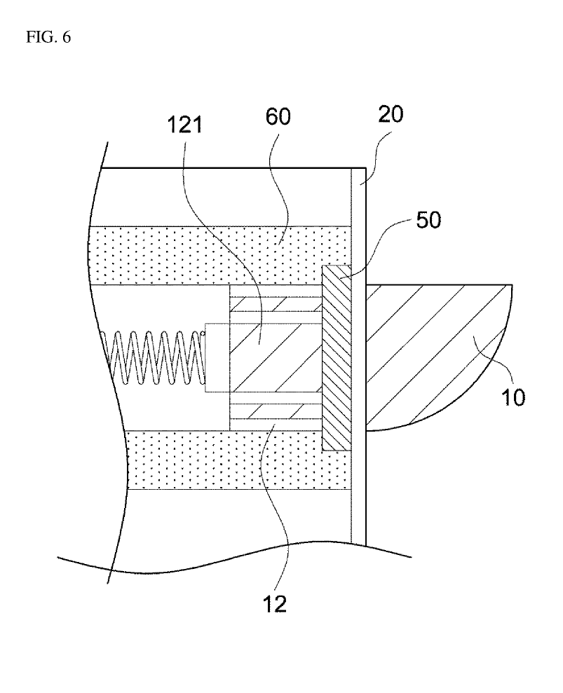

FIG. 6 is a cross-sectional view when a fixing pin 50 is installed at the latch bolt 10 at which the guide protrusion 121 is formed according to one embodiment of the present invention.

Referring to FIG. 6, the guide protrusion 121 is formed at a portion of the latch shaft 12 inserted into the inside of the mortise 30 to prevent the latch bolt 10 from being separated in one side direction and more stably install the latch bolt 10. The fixing pin 50 may prevent the latch bolt 10 from being separated by being in contact with and supporting the guide protrusion 121. Specifically, the guide protrusion 121 formed on the latch shaft 12 inserted in the mortise 30 may be in contact with the fixing pin 50, and the guide protrusion 121 and the fixing pin 50 are in contact with and support each other to prevent the latch bolt 10 from being separated.

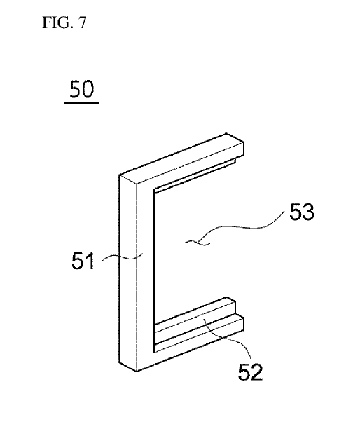

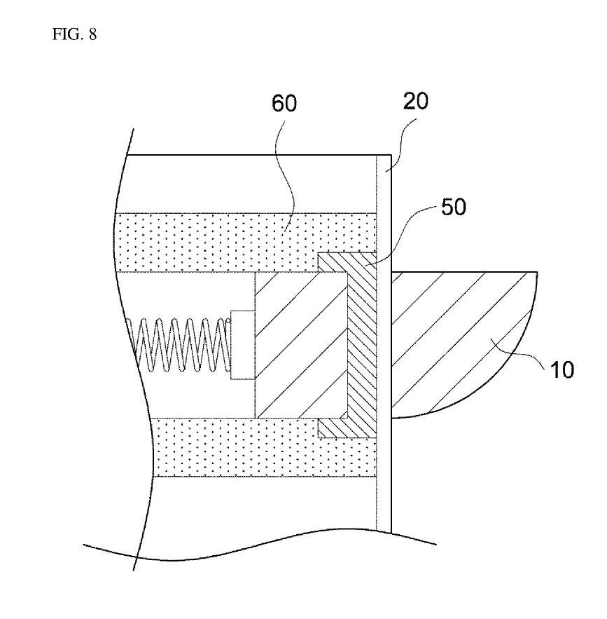

The fixing pin 50 may be positioned at any one place of the face plate 20, the mortise 30, and between the face plate 20 and the mortise 30 to be in contact with and support the latch shaft 12. The fixing pin 50 may prevent the latch bolt 10 from being separated in one side direction and allow the latch bolt 10 to be installed in the mortise 30. The fixing pin 50 in a shape of surrounding at least a portion of the latch bolt 10 may be in contact with a bracket 60 which surround a side of the portion in which the latch bolt 10 is formed inside the mortise 30. FIGS. 7 and 8 are views illustrating a bent arm portion 52 of the fixing pin 50 being disposed according to one embodiment of the present invention.

Referring to FIGS. 7 and 8, the arm portion 52 of the fixing pin 50 may be formed to be bent in an inward direction of the other side of the mortise 30. By forming the arm portion 52 to be bent in an inward direction of the other side of the mortise 30, solidity of the fixing pin 50 may be strengthened. A portion of the latch bolt 10 may be in contact with and support the bent portion of the arm portion 52, thereby force received by the fixing pin 50 may be dispersed even when external force is exerted, and simultaneously a supporting force may be strengthened.

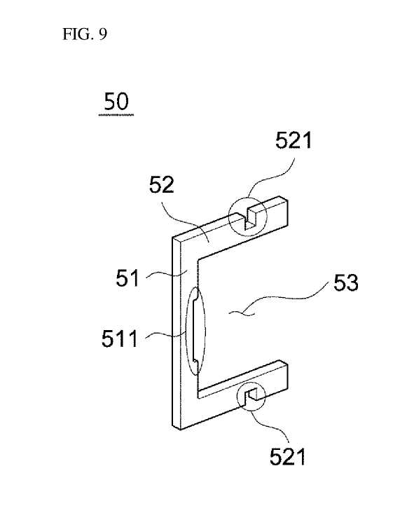

FIG. 9 is a view illustrating the fixing pin 50 in which a concave groove is formed according to one embodiment of the present invention.

Referring to FIG. 9, a first concave groove 511 may be formed in the base portion 51 and a second concave groove 521 may be formed in the arm portion 52.

The first concave groove 511 may be formed in the base portion 51 of the fixing pin 50 for easily detaching the fixing pin 50 installed. The first concave groove 511 may have a size and shape the same as or similar to those of the detaching groove formed in the cover 40. When the fixing pin 50 is installed in the mortise 30, the first concave groove 511 may be formed at a position corresponding to a position of the detaching groove. Therefore, a screwdriver or pin may be put into the detaching groove formed in the cover 40 and the first concave groove 511 to easily detach the fixing pin 50 from a state in which the fixing pin 50 is inserted.

The second concave groove 521 may stably fix the fixing pin 50 and the bracket 60 when the fixing pin 50 is installed. A protrusion 70 which connects the fixing pin 50 and the bracket 60 may be disposed.

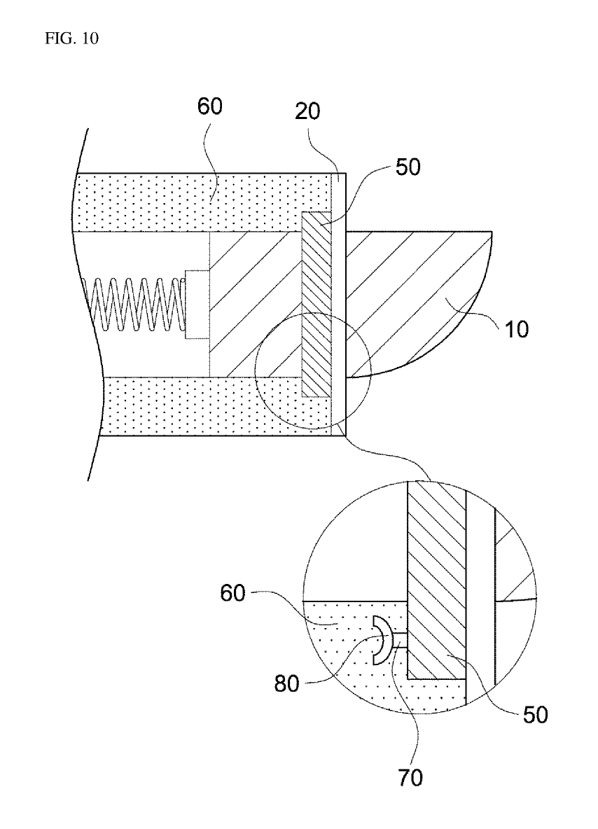

FIG. 10 is a cross-sectional view illustrating the mortise device 100 according to one embodiment of the present invention.

Referring to FIG. 10, a leaf spring 80 may be disposed at the bracket 60 to disperse a force received when a door is opened and closed. The fixing pin 50 and the bracket 60 may be fixed by the protrusion 70 and the leaf spring 80. The leaf spring 80 may be disposed inside the bracket 60, and the fixing pin 50 and the leaf spring 80 in the bracket 60 may be connected using the protrusion 70. Here, a place at which the protrusion 70 is disposed at the fixing pin 50 may be the second concave groove 521.

According to the embodiment of the present invention, the mortise device in which the latch bolt direction is easily switched between counterclockwise direction and clockwise direction without a disassembly can be provided.

In addition, direction of the latch bolt is easily switched, and separation of the latch bolt due to an impact can be prevented when a door is opened and closed.

While the present invention has been described in connection with exemplary embodiments, it should be understood to those skilled in the art that various modifications may be made from the embodiments described above without departing from the spirit and scope of the invention. Accordingly, the scope of the present invention is not limited to the embodiments described above and should be defined according to the attached claims and equivalent scope thereof.

### REFERENCE NUMERALS

10: LATCH BOLT

11: LATCH FRONT END

12: LATCH SHAFT

121: GUIDE PROTRUSION

20: FACE PLATE

30: MORTISE

40: COVER

41: LEAD-IN SLOT

50: FIXING PIN

51: BASE PORTION

52: ARM PORTION

53: LATCH HOLE

511: FIRST CONCAVE GROOVE

512: SECOND CONCAVE GROOVE

60: BRACKET

70: PROTRUSION

80: LEAF SPRING

100: MORTISE DEVICE

What is claimed is:

1. A mortise device comprising:
a mortise installed at a door;
a face plate coupled to a first side surface of the mortise;
a latch bolt configured to thrust out of or configured to retract into the first side surface of the mortise;
a guide protrusion formed on the latch bolt; and
a fixing pin configured to allow the latch bolt to be installed in the mortise.

2. The mortise device of claim 1, wherein the fixing pin is positioned at one of the face plate and the mortise.

3. The mortise device of claim 2, wherein one of the face plate and the mortise includes a lead-in slot configured to position the fixing pin.

4. The mortise device of claim 1, wherein the fixing pin is positioned between the face plate and the mortise.

5. The mortise device of claim 1, wherein the fixing pin includes:
a base portion; and
an arm portion, and
wherein the arm portion bent from the base portion in an inward direction of the mortise.

6. The mortise device of claim 1, wherein the fixing pin is configured to prevent the latch bolt from being separated by being in contact with the guide protrusion.

7. The mortise device of claim 1, wherein the fixing pin is configured to allow the latch bolt to be detached from and installed in the mortise.

8. A mortise device comprising:
a mortise installed at a door;
a face plate coupled to the mortise;
a latch bolt configured to thrust out of or configured to retract into the mortise, the latch bolt comprising a guide protrusion formed on an outer surface of the latch bolt; and
a fixing pin provided between the guide protrusion of the latch bolt and the door and configured to prevent the latch bolt from being separated from the mortise.

9. The mortise device of claim 1, wherein the guide protrusion contacts the fixing pin to prevent the latch bolt from being separated from the mortise.

10. The mortise device of claim 1, wherein the fixing pin is detachably attached to the latch bolt.
